(19) United States
(12) Patent Application Publication
(10) Pub. No.: US 2002/0057004 A1
(43) Pub. Date: May 16, 2002

(54) Frame assembly for a motor vehicle

(76) Inventors: Brian Corcoran, Oxford, MI (US); Richard Ashley, Berkley, MI (US)

Correspondence Address: PILLSBURY WINTHROP LLP, 1600 TYSONS BOULEVARD, MCLEAN, VA, 22102, US

(21) Appl. No.: 09/874,370

(22) Filed: Jun. 6, 2001

Related U.S. Application Data
(60) Provisional application No. 60/209,803, filed on Jun. 7, 2000.

(51) Int. Cl. B62D 23/00

(52) U.S. Cl. 296/203.01

(57) ABSTRACT

A frame assembly for a motor vehicle, the illustrated embodiment including forward and rearward modules each comprising a pair of first and second longitudinally extending, laterally spaced tubular hydroformed side rail members and a tubular hydroformed U-shaped member. Each U-shaped member including a pair of leg portions extending integrally from opposite ends of a cross portion thereof. Each leg portion being connected to and extending upwardly from a respective side rail member and the respective cross portion being generally vertically spaced above and extending laterally with respect to its respective side rail members. A rearward wall structure being connected between each pair of leg portions of the U-shaped members. The modules being capable of being assembled to one another such that a forward end portion of each rearward side rail member is connected to a rearward end portion of a respective forward side rail member.

This application claims priority to U.S. Provisional Patent Application Serial No. 60/209,803, filed Jun. 7, 2000, the entire contents of which are incorporated herein by reference.

### FILED OF THE INVENTION

The present invention is generally related to motor vehicle frame assemblies and more particularly to a frame assembly of tubular hydroformed construction.

### BACKGROUND OF THE INVENTION

Conventional prior art motor vehicle frame assemblies are typically formed by stamping several structural components and then welding these individually stamped structures together. In more recent years, stamped and welded frame members have to some extent been replaced by hydroformed frame members.

Hydroforming is a technique whereby high pressure fluid is used to outwardly expand a longitudinally extending tubular blank into conformity with surfaces of a die cavity. The hydroformed frame member can have a wide range of geometries previously unachievable on a practical, cost-effective basis. In addition, hydroforming results in frame components with increased strength, reduced weight, reduced number of parts, reduced manufacturing costs, and improved dimensional accuracy.

While hydroforming has been proposed for vehicle space frames and ladder frame side rail components, the benefits of hydroforming have not been heretofore realized in areas for forming and supporting rear wall and front wall structures.

A modular approach to frame assembly construction can extend the useful life of frame member manufacturing equipment because this approach allows certain portions of a frame assembly to be reused while allowing other portions to be updated. Modularity of design also offers flexibility and economies in the assembly process.

### SUMMARY OF THE INVENTION

It is an object of the present invention to provide a unique, modular vehicle frame which exploits the benefits of hydroforming in a manner not realized heretofore. To meet the object identified above, the present invention provides a frame assembly for a motor vehicle, the frame assembly comprising a rearward module comprising a pair of first and second longitudinally extending, laterally spaced tubular hydroformed rearward side rail members and a tubular hydroformed rearward U-shaped member. The rearward U-shaped member includes a pair of leg portions extending integrally from opposite ends of a cross portion thereof. Each leg portion of the rearward U-shaped member is connected to and extends upwardly from a respective rearward side rail member and the cross portion of the rearward U-shaped member is generally vertically spaced above and extends laterally with respect to the rearward side rail members. A rearward wall structure is connected between the leg portions of the rearward U-shaped member. The frame assembly also includes a forward module. The forward module includes a pair of first and second longitudinally extending, laterally spaced tubular hydroformed forward side rail members and a tubular hydroformed forward U-shaped member. The forward U-shaped member includes a pair of leg portions extending integrally from opposite ends of a cross portion thereof. Each leg portion of the forward U-shaped member is connected to and extends upwardly from a respective forward side rail member and the cross portion of the forward U-shaped member is generally vertically spaced above and extends laterally with respect to the forward side rail members. A forward wall structure is connected between the leg portions of the forward U-shaped member. The modules are assembled to one another such that a forward end portion of each rearward side rail member is connected to a rearward end portion of a respective forward side rail member.

The invention further provides a method of forming a frame assembly for a motor vehicle. The method includes the steps of forming each of a pair of rearward side rail members, each of a pair of forward side rail members, and each of a pair of forward and rearward U-shaped members in a hydroforming procedure wherein a tubular blank is internally pressurized and expanded into conformity with surfaces defining a die cavity. The method next calls for providing a rearward wall structure and a forward wall structure. The method then calls for assembling the rearward module so that the rearward side rail members extend longitudinally and in laterally spaced relation, associated leg portions of the rearward U-shaped member are connected to and extend upwardly from a respective rearward side rail member, and the rearward wall structure is connected between the leg portions of the rearward U-shaped member. The method further calls for assembling the forward module so that the forward side rail members extend longitudinally and in laterally spaced relation, associated leg portions of the forward U-shaped member are connected to and extend upwardly from a respective forward side rail member, and the forward wall structure is connected between the leg portions of the forward U-shaped member. The assembled modules are connected to one another by connecting a forward end portion of each rearward side rail member to a rearward end portion of a respective forward side rail member.

It is a further object of the present invention to provide a frame structure for a motor vehicle having a pair of longitudinally extending, laterally spaced tubular hydroformed side rail members and a tubular hydroformed U-shaped member. The tubular hydroformed U-shaped member includes a pair of leg portions and a cross portion. Each leg portion is connected to a respective one of the side rail members. The cross portion is integrally formed with the leg portions and is vertically spaced above and extends laterally with respect to the side rail members. The frame structure further includes a stamped wall structure formed from sheet metal. The wall structure is connected between the leg portions of the U-shaped member.

### BRIEF DESCRIPTION OF THE DRAWINGS

FIG. 1 is a partially exploded perspective view of a rearward module and a forward module of a frame assembly constructed according to the principles of the present invention;

FIG. 2 is a view similar to FIG. 1 except with a rearward wall structure and a rearward floor structure of the rearward module removed and a forward wall structure of the forward module removed;

FIG. 3 is a perspective view of the frame assembly with a central floor structure mounted thereto;

FIG. 4 is a side view of the frame assembly with the central floor structure mounted thereto; and

FIG. 5 is a schematic representation of a hydroforming die assembly with a tubular blank disposed therein.

### DETAILED DESCRIPTION OF THE DRAWINGS

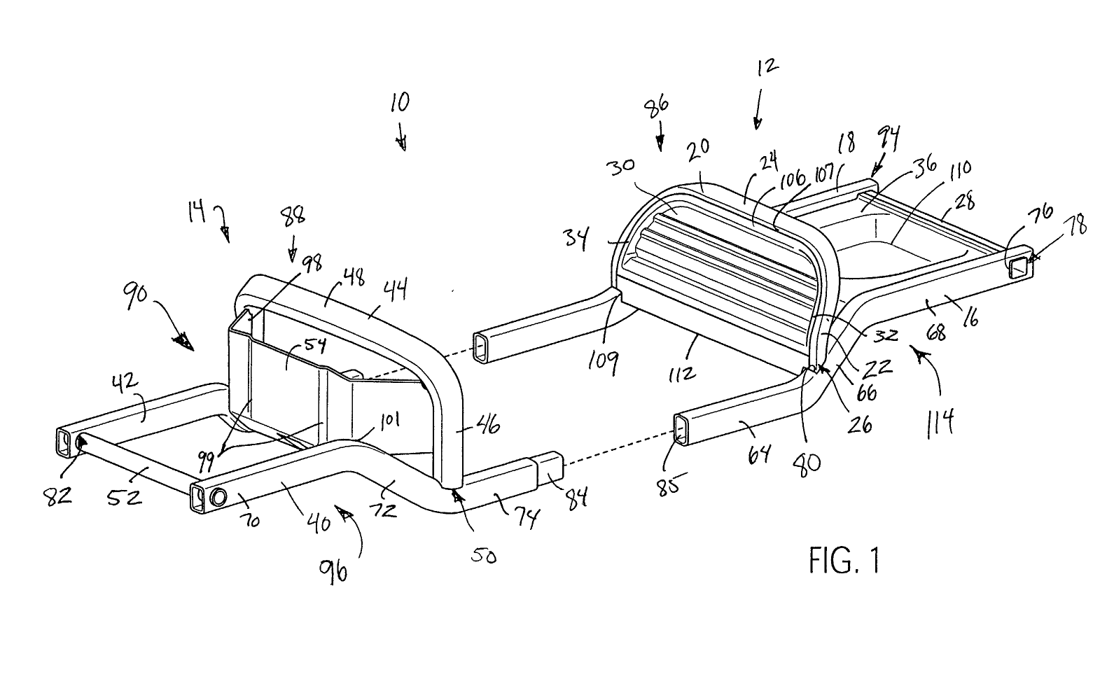

A motor vehicle frame assembly 10 constructed according to the principles of the present invention is shown in the partially exploded view of FIG. 1. The frame assembly 10 includes a rearward module 12 and a forward module 14. FIG. 1 shows the assembled rearward and forward modules 12, 14 in exploded relation to one another.

The rearward module 12 includes a pair of first and second longitudinally extending, laterally spaced tubular hydroformed rearward side rail members 16, 18 and a tubular hydroformed inverted rearward U-shaped member 20. As explained below, each of the tubular hydroformed members 16, 18, 20 is defined by an outwardly deformed in metallic wall fixed in a predetermined exterior surface configuration. The inverted rearward U-shaped member 20 includes a pair of leg portions 22 extending integrally from opposite ends of a cross portion 24 thereof. Each of the leg portions 22 is connected to and extends upwardly from a respective rearward side rail member 16, 18.

Each of the leg portions 22 forms a joint 26 with the associated rearward side rail member 16, 18. The construction of the joint 26 is considered in detail below. The cross portion 24 of the forward U-shaped member 20 is spaced generally vertically above and extends laterally with respect to the rearward side rail members 16, 18.

A laterally extending rearward connecting structure 28 is connected between rearward portions of the rearward side rail members 16, 18 at a longitudinal position spaced rearwardly from the inverted rearward U-shaped member 20. A laterally extending rearward wall structure 30 is connected at each end 32, 34 thereof to a respective one of the pair of leg portions 22 of the rearward U-shaped member 20. A laterally extending rearward floor structure 36 is connected between the pair of rearward side rail members 16, 18 at a longitudinal position generally between the rearward U-shaped member 20 and the rearward connecting structure 28.

The forward module 14 includes a pair of first and second longitudinally extending, laterally spaced tubular hydroformed forward side rail members 40, 42 and a tubular hydroformed forward inverted U-shaped member 44. Each of the tubular hydroformed members 40, 42, 44 is defined by an outwardly deformed metallic wall fixed in a predetermined exterior surface configuration. The forward U-shaped member 44 includes a pair of leg portions 46 extending integrally from opposite ends of a cross portion 48 thereof. Each of the leg portions 46 is connected to and extends upwardly from a respective forward side rail member 40, 42 (at a joint 50 that is of similar construction to joint 26). The cross portion 48 is spaced generally vertically above and extends laterally with respect to the forward side rail members 40, 42.

A laterally extending forward connecting structure 52 is connected between forward end portions of the forward side rail members 40, 42 at a position spaced forwardly from the forward U-shaped member 44. A laterally extending forward wall structure 54 is mounted on the forward U-shaped member 44. Each end of the forward wall structure 54 is connected to a respective one of the pair of leg portions 46 of the forward U-shaped member 44.

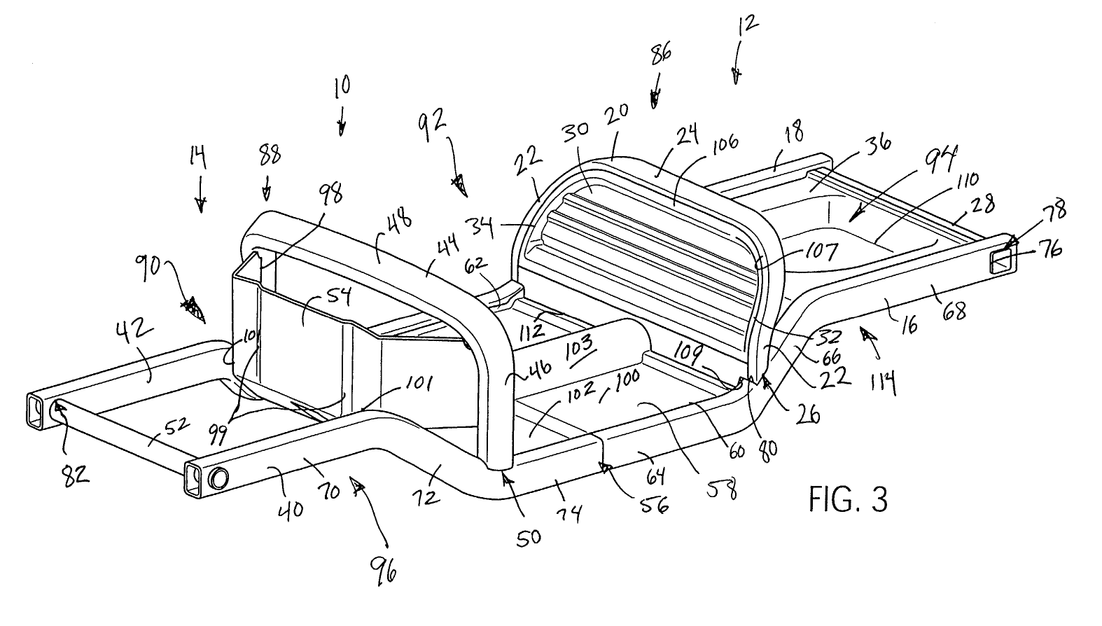

The assembled modules 12, 14 are shown in FIG. 3. The modules 12, 14 are assembled to one another such that the forward end portion of each forward side rail member 16, 18 is connected to a rearward end portion of the respective forward side rail member 40, 42 at joints 56 (see FIG. 3). Preferably, the frame assembly 10 further includes a central floor structure 58 (see FIG. 3). Opposite sides 60, 62 of the central floor structure 58 are fixed to the pairs of connected forward and rearward side members 16, 40 and 18, 42, respectively, of the assembled modules 12, 14 at a position generally between the forward U-shaped member 44 and the rearward U-shaped member 20.

Preferably the rearward floor structure 36, the rearward wall structure 30, the forward wall structure 54 and the central floor structure 58 are metal structures that are formed from sheet metal blanks that have been shaped by stamping.

The rearward side rail members 16 and 18 are of mirror image construction and the forward side rail members 40 and 42 are of mirror image construction. Consequently only members 16 and 40 are discussed in detail, but the discussion applies equally to members 18 and 42.

The rearward side rail member 16 includes a forward essentially straight portion 64 which transitions into an upwardly extending central portion 66 which in turn transitions into an essentially straight rearward portion 68. The forward side rail member 40 includes a forward essentially straight portion 70 which transitions into an angularly downwardly extending central portion 72 which in turn transitions into an essentially straight rearward portion 74. Preferably straight portions 64, 69 and 70, 74 extend parallel to each other.

The rearward connecting structure 28 is preferably a tubular metallic structure formed by roll forming and then seam welding a metallic sheet. Alternatively, the rearward connecting structure 28 can be a tubular member, preferably hydroformed, or can be a non-tubular structure (i.e. stamped). In the preferred embodiment, the rearward connecting structure 28 has a rectangular cross structure. Preferably a pair of aligned openings 76 are cut in the opposing vertical wall portions of each rearward side rail member 40, 42 and each end of the connecting structure 28 is welded within a pair of openings 76 to form a pair of joints 78 to secure the rearward connecting structure 28 between the rearward side rail members 16, 18. The openings 76 can be formed by laser cutting or by any other appropriate method. The rearward connecting structure 28 can be welded in the openings 76 by mig welding or by any other appropriate welding method.

Preferably an upper wall portion of each rearward side rail members 16, 18 is cut out and removed to form an upwardly facing opening 80 in each side rail member 16, 18. A free end of each leg portion 22 of the rearward U-shaped member 24 is positioned within the opening 80 and each leg portion 22 is welded in the associated opening 80 to form the joint 26. Preferably the opening 80 is formed by laser cutting, although any appropriate cutting method can be used, and the leg portion 22 is mig welded in the opening 80, although any appropriate welding method can be used.

Preferably the forward connecting structure 52 is a tubular metallic structure that is formed by roll forming and then seam welding a metallic sheet. Alternatively, the forward connecting structure 52 can be a tubular hydroformed member or can be a non-tubular structure, i.e. a non-tubular, structure. Preferably, the forward connecting structure 52 has a circular cross section. Each end of the forward connecting structure 52 is connected at a joint 82 to an associated forward side rail member 40, 42. Preferably, each joint 82 is of similar construction to joint 78. It can be understood from FIG. 3 that the only difference between the joints 78 and 82 is that the shape of the openings for the respective connecting structures 28 and 52.

The structure of the joints 56 that connect the rearward and forward modules 12, 14 to one another can be understood from FIG. 3. Specifically, a rearward-most end portion 84 of each forward side rail member 40, 42 is of reduced diameter so that each end portion 84 can be telescopically received within an opening 85 in the forward-most end portion of each rearward side rail member 16, 18. Each pair of telescopically interengaged forward and rearward side rail members 16, 40 and 18, 42 are welded to form the joints 56. It can be understood that the configurations of the telescopically interengaging portions 84, 85 of the members 40, 42 and 16, 18, respectively, can be reversed so that the portion of reduced diameter is integrally formed on the rearward side rail members 16, 18.

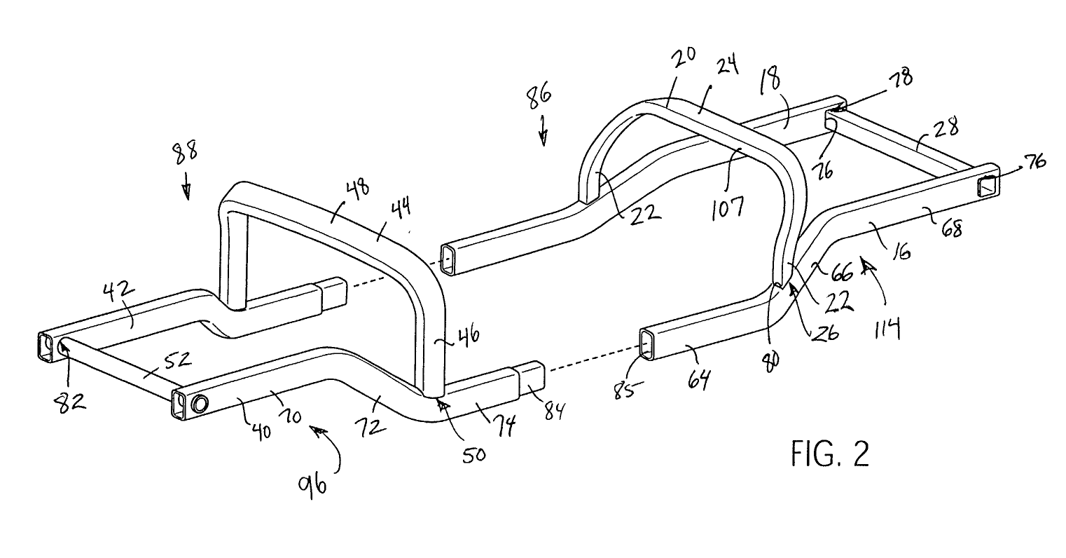

It can be appreciated from FIG. 2 that the rearward side rail members 16, 18, the rearward connecting structure 28 and the rearward U-shaped member 30 can be assembled to form a rearward frame assembly 86 and that the forward side rail members 40, 42, the forward connecting structure 52 and the forward U-shaped member 44 can be assembled to form a forward frame assembly 88. It can be understood from a comparison of FIGS. 1 and 2 that it is within the scope of the invention to construct the forward and rearward frame assemblies 88, 86 and then to secure the respective wall and floor structures 30, 36, 54 thereto to form the two assembled modules 12, 14, which assembled modules are then connect to one another. It can be understood, however, that this is illustrative only and not intended to imply any limitation on the order in which the structures 28, 30, 36, 52, 54, and the members 16, 18, 20, 40, 42, 44 are interconnected during the construction of the forward module and rearward module.

The rearward floor structure 36 and the rearward wall structure 30 are secured to the rearward frame assembly 86 to form the rearward module 12. The forward wall structure 54 is secured to the forward frame assembly 88 to form the forward module 14. Preferably, the assembled forward and rearward modules 12, 14 are then connected together to form the frame assembly 10. Preferably after the assembled rearward and forward modules 12, 14 are connected together to form the frame assembly 10, the central floor structure 58 is mounted on the frame assembly 10. The assembled frame assembly 10 with the central floor structure 58 secured thereto is shown in FIG. 3.

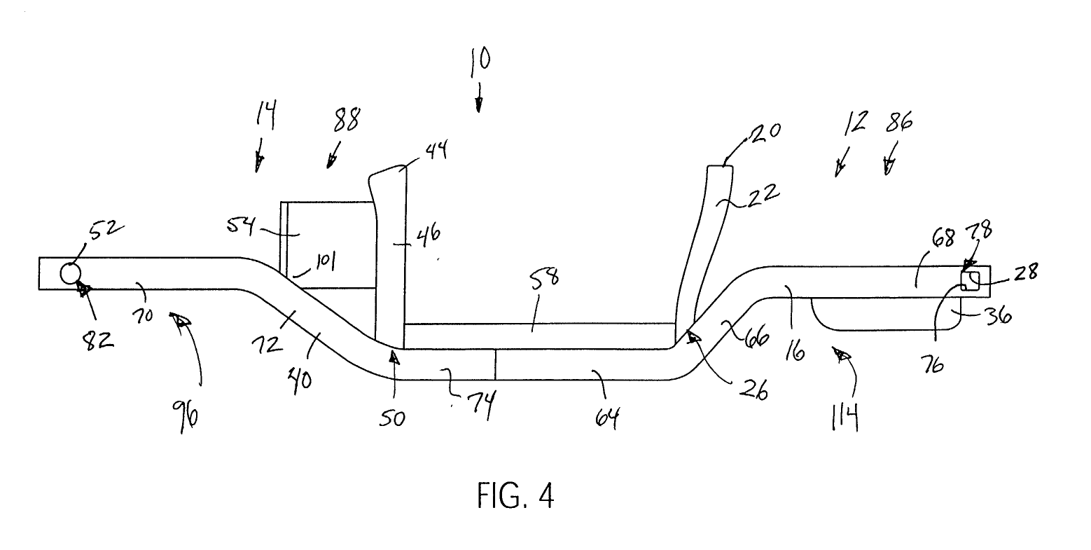

It can be best appreciated from FIGS. 3 and 4 that the frame assembly 10 generally defines an engine compartment area 90, a passenger compartment area 92, and a storage or trunk area 94.

The forward 70 and central 72 portions of the forward side rail members 40, 42 cooperate to define a front wheel well 96 (best seen in the side view of FIG. 4) and provide structure for mounting the vehicle front suspension (not shown), the front wheels (not shown), and the vehicle fenders (not shown). The forward wall structure 54 provides a protective barrier and a firewall between the engine compartment 90 and a passenger compartment 92. The forward wall structure 54 is preferably a stamped sheet metal structure and is preferably secured to the inner surfaces of the leg portions 46 of the forward U-shaped member 44 by single-sided spot welds, generally indicated at 98. Preferably, the forward wall structure 54 is corrugated as at 99 to rigidify the forward wall structure so that the wall structure 54 can better resist deformation during impact. Preferably and optionally, lower side portions 101 of the forward wall structure 54 are secured by welding or by other suitable method to respective central portions of the forward side rail members 40, 42 to further secure the forward wall structure 54 to the forward frame 88.

It can be understood from FIG. 3 that the exemplary embodiment of the frame assembly 10 shown therein is suitable for constructing a two-door, two seat sports car-type vehicle. It is contemplated to mount a vehicle door (not shown) on each side of the frame assembly 10. Specifically, it is contemplated to pivotably mount a vehicle door on each leg portion 46 of the forward U-shaped member 44 with a pair of hinges. It is contemplated to mount a door latch (not shown) on each leg portion 22 of the rearward U-shaped member 20 to releasably hold each of the two doors closed. The leg portions 46 of the forward U-shaped member 44 thus constitute door hinge pillars on each side of the frame assembly 10 to facilitate hinged attachment of a pair of vehicle doors.

The cross portion 48 of the forward U-shaped member 44 provides support structure for a vehicle front windshield (not shown) and for a vehicle instrument panel and dashboard (not shown) located inside the passenger compartment 92 of the assembled motor vehicle.

Preferably the central floor structure 58 is of one-piece construction and is shaped by stamping, or by any other appropriate metal forming method, to include a pair of seat support areas 100 on each side of the vehicle passenger compartment 92 and a pair of feet support areas 102 on each side of the passenger compartment 92 at a position forward of the seat support areas 100. Typically, each of a pair of bucket-type seat assemblies (not shown) is bolted to a respective seat support area 100. A longitudinally extending central portion 103 of the floor structure 58 arches upwardly to accommodate part of the vehicle transmission (not shown) mounted generally below the central floor structure 58 of the assembled vehicle.

The rearward wall structure 30 is mounted on the rearward U-shaped member 20 and generally comprises a protective wall, or “cargo wall”, between the passenger compartment 92 and the storage compartment 94 of the assembled vehicle. Preferably the rearward wall structure 30 is shaped by stamping, although any known metal forming method can be used to construct the wall structure 30, so that it substantially covers or closes off the area defined by the cross portion 24 and leg portions 22 of the rearward U-shaped member 20 between the passenger compartment 92 and the storage area 94. Specifically, an outer peripheral edge portion 106 on the wall structure 30 is shaped to conform to a forwardly facing surface 107 on the rearward U-shaped member 20. The edge portion 106 and adjacent portions of the rearward wall structure 30 are preferably secured to the rearward U-shaped member 20 by a series of single sided spot welds, although any appropriate method for connecting metal structures together, including any appropriate welding method, can be used to secure the edge portion 106 to the rearward U-shaped member 20.

Lower corner portions 109 of the rearward wall structure 30 are cut out and removed, preferably during the stamping operation, to form a pair of notches sized to fit over the adjacent portions of the rearward side rail members 16, 18. A lower edge 112 of the rearward wall structure 30 is in contact with a back edge portion of the central floor structure 58 and is preferably secured thereto, by a series of welds or by other appropriate method. Thus, rearward portions of the central floor structure 58 are connected to lower portions of the rearward wall structure 30 and an upper portion of the rearward wall structure 30 is connected or affixed to the cross portion 24 of the rearward U-shaped member 20.

A central portion of the rearward wall structure 30 is corrugated to rigidify and strengthen the rearward wall structure 30 so that the rearward wall structure 30 resists deformation during impact.

The rearward floor structure 36 is preferably shaped by stamping, or by other suitable metal shaping method to have a central recess 110 constructed and arranged to receive a spare tire (not shown) for the vehicle. Preferably a rearward edge portion 112 of the rearward floor structure 36 is connected to the rearward connecting structure 28 by welding or by other suitable method. A forward edge portion of the rearward floor structure 36 can optionally be secured by welding or the like to a bottom edge portion of the rearward wall structure 30, to a rearward edge portion of the central floor structure 58, or both. Preferably, the side portions of the central floor structure 58 and the side portions of the rearward floor structure 36 are welded to the associated forward and/or rearward side rail members 16, 18, 40, 42, although these edges can be secured thereto by any other appropriate method.

The central and rearward portions 66, 68 of the rearward side rail members 16, 18 generally define a pair of rear wheel wells 114, best seen in the side view of FIG. 4. The cross portion 24 of the rearward U-shaped member 20 provides support structure for a rearward windshield (not shown) and may provide support structure for an optional retractable mechanical vehicle roof, i.e., a convertible-type vehicle roof, not shown.

The U-shaped members are bent prior to being placed in a hydroforming die assembly and can be hydroformed according to the teachings of U.S. Pat. No. 5,953,945, issued Sep. 21, 1999, entitled METHOD AND APPARATUS FOR WRINKLE-FREE HYDROFORMING OF ANGLED TUBULAR PARTS, hereby incorporated by reference in its entirety. The side rails can be hydroformed in accordance with the teachings of U.S. Pat. No. 5,979,201, issued Nov. 9, 1999, entitled HYDROFORMING DIE ASSEMBLY FOR PINCH-FREE TUBE FORMING, hereby incorporated by reference in its entirety into the present application.

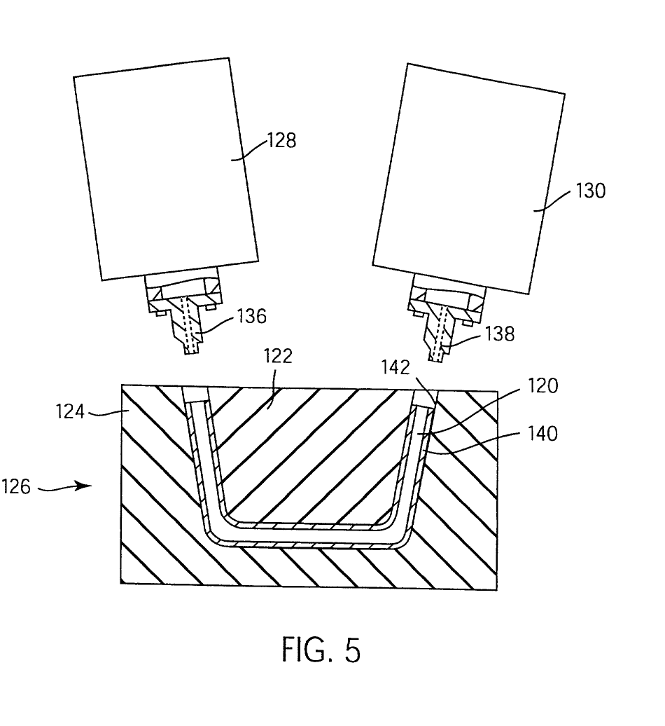

With reference to FIG. 5 for exemplary purposes only, a U-shaped tubular blank 120 is placed between the die halves 122, 124 of the die assembly 126 and the assembly is closed. The tubular blank 120 is preferably immersed in a fluid bath so that it is filled with hydroforming fluid. A hydroforming ram assembly 128, 130 is engaged with each end of the tubular blank 120 such that a ram member 136, 138 of each assembly 128, 130 seals an end of a tubular blank 120. The ram members 136, 138 include hydraulic intensifiers which can intensify the hydroforming fluid, thereby increasing the fluid pressure of the fluid within the blank 120 to outwardly deform the tubular metallic wall, generally designated 140, of the tubular blank 120 into conformity with the die surfaces 142 of the die cavity to thereby form a hydroformed member having an exterior surface that is fixed into a predetermined regular (i.e., uniform) or irregular (i.e., non-uniform) configuration.

The ram members 136, 138 push axially inwardly on opposite ends of the blank 120 to create metal flow within the blank 120 during outward expansion. The fluid pressure and the axial pressure are independently controllable. Preferably, the ends of the tubular blank 120 are pushed axially inwardly during the hydroforming operation to maintain the wall thickness of the fully formed hydroformed member within a predetermined range of the wall thickness of the initial tubular blank 120. The resulting structure can be used to provide the U-shaped members 20 or 44.

It can be understood that the rearward module 12 may be assembled by connecting the hydroformed members 16, 18, 20 and the components 28, 30, 36 to one another in any appropriate order. Similarly, it can be understood that the forward module 14 may be assembled by connecting the hydroformed members 40, 42, 44 and the components 52 and 54 to one another in any appropriate order. Preferably, the connecting of the rearward and forward modules 12, 14 to one another occurs prior to the provision of the central floor structure 58.

It can be understood that the frame assembly 10 is intended to be exemplary only. The frame assembly 10 can be used to construct a two-door sports car-type vehicle that has a convertible-type roof or, alternatively, a fixed-(i.e., non-convertible) type roof. It can also be understood from the above description and from the drawings that many variations of the frame assembly are contemplated. For example, although the frame assembly 10 is suited for constructing a two-door sports car-type vehicle, it is contemplated to construct a modular hydroformed frame assembly for a four-door sedan-type vehicle.

Furthermore, since the present frame assembly 10 utilizes modular construction, it can be understood that it is contemplated to construct other embodiments of forward modules (different from forward module 14) for use with the rearward module 12 and similarly, it is contemplated to construct other embodiments of rearward modules (different from rearward module 12) for use with the forward module 14. For example, the rearward module 12 can be used with a forward module that is similar to the forward module 14 except that the forward side rail members are hydroformed to have a different construction (by having, for example, a shorter or longer length, a different longitudinal or cross sectional geometry and so on) from the construction of side rail members 40, 42. In this way, the forward module can be reconfigured to accommodate a different body style for the front portion of a vehicle constructed using the frame assembly, to accommodate a smaller or larger engine or different types of front wheel suspension. Similarly, it is contemplated to construct a wide range of rearward modules for use with the forward module 14 to provide vehicles having different body styles, different trunk sizes and so on.

While the invention has been disclosed and described with reference to a single embodiment of a frame assembly, it is apparent this embodiment is exemplary only and therefore that variations and modifications of this exemplary embodiment are within the spirit and scope of the invention. Therefore, the following claims are intended to cover all such modifications, variations, and equivalents thereof in accordance with the principles and advantages noted herein.

What is claimed is:

1. A frame assembly for a motor vehicle, said frame assembly comprising:
a rearward module comprising a pair of first and second longitudinally extending, laterally spaced tubular hydroformed rearward side rail members and a tubular hydroformed rearward U-shaped member, said rearward U-shaped member including a pair of leg portions extending integrally from opposite ends of a cross portion thereof, each said leg portion being connected to and extending upwardly from a respective rearward side rail member and said cross portion being generally vertically spaced above and extending laterally with respect to said rearward side rail members, and a rearward wall structure connected between said leg portions of said rearward U-shaped member, and
a forward module comprising a pair of first and second longitudinally extending, laterally spaced tubular hydroformed forward side rail members and a tubular hydroformed forward U-shaped member, said forward U-shaped member including a pair of leg portions extending integrally from opposite ends of a cross portion thereof, each said leg portion being connected to and extending upwardly from a respective forward side rail member and said cross portion being generally vertically spaced above and extending laterally with respect to said forward side rail members, and a forward wall structure connected between said leg portions of said forward U-shaped member,
said modules being assembled to one another such that a forward end portion of each rearward side rail member is connected to a rearward end portion of a respective forward side rail member.

2. A frame assembly as defined in claim 1, further including a laterally extending rearward connecting structure connected between rearward portions of said rearward side rail members at a position spaced rearwardly from said rearward U-shaped member and a laterally extending forward connecting structure connected between forward portions of said forward side rail members at a position spaced forwardly from said forward U-shaped member

3. A frame assembly as defined in claim 2, further including a central floor structure having opposite side portions affixed to respective pairs of connected forward and rearward side members of said assembled modules at a position generally between said forward and said rearward U-shaped members.

4. A frame assembly as defined in claim 3 wherein rearward portions of said central floor structure are connected to lower portions of said rearward wall structure and wherein an upper portion of said rearward wall structure is connected to the cross portion of said rearward U-shaped member.

5. A frame assembly as defined in claim 3, further comprising a rearward floor structure connected between said pair of rearward side rail members at a longitudinal position generally between said rearward U-shaped member and said rearward connecting structure, said rearward floor structure including a central recess constructed and arranged to receive a vehicle spare tire.

6. A frame assembly as defined in claim 5 wherein a rearward edge portion of said rearward floor structure is connected to said rearward connecting structure.

7. A frame assembly as defined in claim 6 wherein a forward edge portion of said rearward floor structure is connected to a lower edge portion of said rearward wall structure.

8. A frame assembly as defined in claim 6 wherein a forward edge portion of said rearward floor structure is connected to said central floor structure.

9. A frame assembly as defined in claim 6 wherein said laterally extending forward and rearward wall structures are each corrugated metallic structures.

10. A frame assembly as defined in claim 9 wherein said forward and rearward connecting structures are of tubular roll formed construction.

11. A method of forming a frame assembly for a motor vehicle, comprising:
forming each of a pair of rearward side rail members, each of a pair of forward side rail members, and each of a pair of forward and rearward U-shaped members in a hydroforming procedure wherein a tubular blank is internally pressurized and expanded into conformity with surfaces defining a die cavity;
providing a rearward wall structure and a forward wall structure;
assembling said rearward module so that said rearward side rail members extend longitudinally and in laterally spaced relation, associated leg portions of said rearward U-shaped member are connected to and extend upwardly from a respective rearward side rail member, and said rearward wall structure is connected between said leg portions of said rearward U-shaped member,
assembling said forward module so that said forward side rail members extend longitudinally and in laterally spaced relation, associated leg portions of said forward U-shaped member are connected to and extend upwardly from a respective forward side rail member, and said forward wall structure is connected between said leg portions of said forward U-shaped member; and
connecting said rearward and forward modules to one another by connecting a forward end portion of each rearward side rail member to a rearward end portion of a respective forward side rail member.

12. A method as defined in claim 11 wherein said providing further includes providing a rearward connecting structure and a forward connecting structure, wherein said assembling said rearward module further includes connecting said rearward connecting structure between rearward end portions of said rearward side rail members at a position spaced rearwardly from said rearward U-shaped member, and wherein said assembling said forward module further includes connecting said forward connecting structure between forward end portions of said forward side rail members at a position spaced forwardly of said forward U-shaped member.

13. A method as defined in claim 12, further comprising providing a central floor structure and wherein following said connecting of said rearward and forward modules to one another, affixing said central floor structure to respective pairs of connected forward and rearward side members of said assembled modules at a position generally between said forward and said rearward U-shaped members.

14. A method as defined in claim 13 wherein said affixing further includes affixing rearward portions of said central floor structure to lower portions of said rearward wall structure and affixing an upper portion of said rearward wall structure to the cross portion of said rearward U-shaped member.

15. A method as defined in claim 12, further comprising connecting a rearward floor structure between said pair of rearward side rail members at a position generally between said rearward U-shaped member and said rearward connecting structure, said rearward floor structure having a central recess constructed and arranged to receive a vehicle spare tire.

16. A method as defined in claim 15 wherein said assembling of said modules includes connecting a rearward edge portion of said rearward floor structure to said rearward connecting structure.

17. A method as defined in claim 16 wherein each of said laterally extending forward and rearward wall structures is a corrugated metallic structure.

18. A method as defined in claim 17 wherein said forward and said rearward connecting structures are of tubular roll formed construction.

19. A frame structure for a motor vehicle, comprising:
a pair of longitudinally extending, laterally spaced tubular hydroformed side rail members;
a tubular hydroformed U-shaped member having a pair of leg portions and a cross portion, each leg portion being connected to a respective one of said side rail members, said cross portion being integrally formed with said leg portions and being vertically spaced above and extending laterally with respect to said side rail members; and
a stamped wall structure formed from sheet metal and connected between said leg portions.
